(19) United States
(12) Patent Application Publication
(10) Pub. No.: US 2013/0077117 A1
(43) Pub. Date: Mar. 28, 2013

(54) IMAGE PICKUP APPARATUS, METHOD FOR CONTROLLING THE SAME, AND STORAGE MEDIUM

(71) Applicant: Norihiko Kobayashi, Fujisawa-shi (JP)

(72) Inventor: Norihiko Kobayashi, Fujisawa-shi (JP)

(73) Assignee: CANON KABUSHIKI KAISHA, Tokyo (JP)

(21) Appl. No.: 13/612,616

(22) Filed: Sep. 12, 2012

(30) Foreign Application Priority Data
Sep. 22, 2011 (JP) PCT/JP2011/071678

(51) Int. Cl. G06F 15/00

(52) U.S. Cl. 358/1.13

(57) ABSTRACT

A user who does not know a detailed configuration of an information processing apparatus may easily obtain a manual. However, there is a problem in that, after that, the user does not easily recognize which operation is to be performed at which location, according to the manual. When a location at which the user is to perform an operation is not displayed on a display unit, guidance information is displayed which indicates the direction in which the user is to move an image pickup apparatus so as to display the location.

This application claims the benefit of International Patent Application No. PCT/JB2011/071678, filed Sep. 22, 2011, which is hereby incorporated by reference herein in its entirety.

### TECHNICAL FIELD

The present invention relates to an image pickup apparatus, a method for controlling the image pickup apparatus, and a STORAGE MEDIUM.

### BACKGROUND ART

In the related art, one of the methods for viewing manuals of information processing apparatuses, such as PCs (Personal Computers) or MFPs (Multi Function Peripherals), is, for example, a technique described in PTL 1. In PTL 1, a configuration is disclosed in which an information processing apparatus has QR codes (registered trademark) attached thereto to identify the information processing apparatus, and in which the QR codes are read out using an image pickup apparatus such as a camera-equipped portable telephone, whereby a manual corresponding to the information processing apparatus is obtained. Accordingly, the technique described in PTL 1 allows a manual corresponding to an information processing apparatus to be easily obtained.

### CITATION LIST

### Patent Literature

PTL 1: Japanese Patent Laid-Open No. 2007-193603

In PTL 1, a user operation after a manual is obtained, e.g., an operation which is necessary to solve an error in an information processing apparatus, is required to be performed after a user understands the manual information and the configuration of the information processing apparatus. However, the configuration of an information processing apparatus such as an MFP is complicated, and many locations at which a user can perform an operation, such as paper feed cassettes or an operation panel, are present. Accordingly, a user who does not know the detailed configuration of an information processing apparatus may easily obtain a manual. However, there is a problem in that, after that, the user does not easily recognize which operation is to be performed at which location, according to the manual.

In view of the above-described problem, an object of the present invention is to display guidance information indicating the direction to a location on which a user is to perform an operation, thereby improving user convenience.

### SUMMARY OF INVENTION

To solve the above-described problem, an image pickup apparatus provided by the present invention includes image pickup means, display means, determination means, and control means. The display means displays an image of an image pickup object picked up by the image pickup means. The determination means determines whether or not an image of a location at which a user is to perform an operation is picked up by the image pickup means, on the basis of the image pickup object. The control means controls the display means so as to display guidance information indicating a direction to the location at which the user is to perform an operation, in the case where the determination means determines that an image of the location at which the user is to perform an operation is not picked up.

Further features of the present invention will become apparent from the following description of exemplary embodiments with reference to the attached drawings.

### BRIEF DESCRIPTION OF DRAWINGS

FIG. 1 is a general view of an image pickup system according to a first embodiment of the present invention.

FIG. 2 is a diagram illustrating the configuration of an MFP 100 according to the first embodiment of the present invention.

FIG. 3 is a diagram illustrating the configuration of an image pickup apparatus 101 according to the first embodiment of the present invention.

FIG. 4 is a diagram illustrating the configuration of a server apparatus 102 according to the first embodiment of the present invention.

FIG. 5A is a diagram illustrating a screen displayed on a display unit 306 of the image pickup apparatus 101 according to the first embodiment of the present invention.

FIG. 5B is a diagram illustrating a screen displayed on the display unit 306 of the image pickup apparatus 101 according to the first embodiment of the present invention.

FIG. 5C is a diagram illustrating a screen displayed on the display unit 306 of the image pickup apparatus 101 according to the first embodiment of the present invention.

FIG. 5D is a diagram illustrating a screen displayed on the display unit 306 of the image pickup apparatus 101 according to the first embodiment of the present invention.

FIG. 6 is a flowchart of the procedure of the MFP 100 according to the first embodiment of the present invention.

FIG. 7 is a flowchart of the procedure of the image pickup apparatus 101 according to the first embodiment of the present invention.

FIG. 8 is a flowchart of the procedure of the server apparatus 102 according to the first embodiment of the present invention.

FIG. 9A is a diagram illustrating a screen displayed on the display unit 306 of the image pickup apparatus 101 according to the first embodiment of the present invention.

FIG. 9B is a diagram illustrating a screen displayed on the display unit 306 of the image pickup apparatus 101 according to the first embodiment of the present invention.

FIG. 10A is a diagram illustrating a screen displayed on the display unit 306 of the image pickup apparatus 101 according to the first embodiment of the present invention.

FIG. 10B is a diagram illustrating a screen displayed on the display unit 306 of the image pickup apparatus 101 according to the first embodiment of the present invention.

### DESCRIPTION OF EMBODIMENTS

Hereinafter, embodiments for embodying the present invention will be described with reference to the drawings. The embodiments described below do not limit the invention according to the scope of the claims, and all combinations of the features described in the embodiments are not necessarily required for the solution means provided by the invention.

### First Embodiment

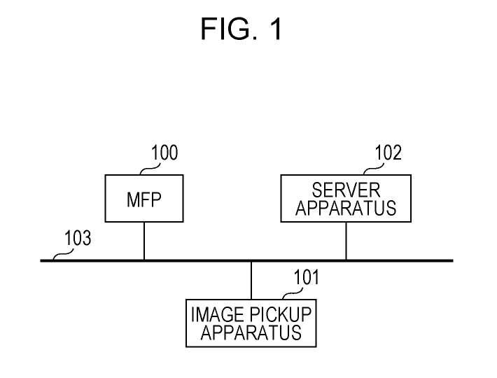

FIG. 1 is a diagram illustrating an image pickup system according to the embodiment. An MFP 100 includes a display such as an LCD and an operating unit, and executes a process, such as printing, copying, or storage of a read-out document, in accordance with an instruction from a user via an operating unit or a command that is input from an external apparatus (not illustrated). The description will be made taking an MFP as one example of an information processing apparatus. However, an information processing apparatus of the present invention is not limited to this, and may be an SFP (Single Function Peripheral), such as a scanner or a printer, or a PC.

An image pickup apparatus 101 is an apparatus including a display, such as an LCD, and a camera using, for example, CCDs. An electronic file (for example, a manual of the MFP 100) is displayed on the display of the image pickup apparatus 101. Examples of the image pickup apparatus 101 include a camera-equipped tablet terminal, a digital camera, and an HMD (head mount display).

A server apparatus 102 stores an electronic file, such as a manual of the MFP 100, and information used to display guidance information described below on the image pickup apparatus 101.

The MFP 100, the image pickup apparatus 101, and the server apparatus 102 are connected so as to be capable of communicating with each other via a network 103. The configuration of the network 103 is not particularly limited, and various configurations, such as a LAN (Local Area Network), the Internet, and wireless communication, may be employed.

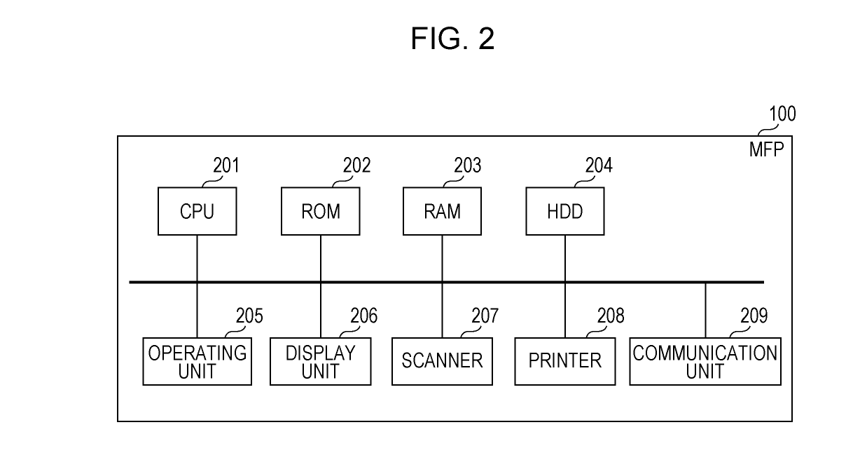

FIG. 2 is a diagram illustrating the configuration of the MFP 100.

A CPU 201 reads out control programs stored in a ROM 202 or an HDD 204 to control the entire MFP 100. The ROM 202 stores information, such as control programs for executing processes according to, for example, flowcharts described below. A RAM 203 is used as a temporary storage area, such as a main memory or a work area of the CPU 201. Similarly to the ROM 202, the HDD 204 stores information such as control programs.

An operating unit 205 is, for example, a keyboard, and transmits information that is input from a user to the CPU 201. A display unit 206 displays, for example, an operation screen or an error screen of the MFP 100. According to the embodiment, the description is made in which the operating unit 205 and the display unit 206 are separately formed. However, they may be integrally formed as in, for example, a liquid crystal panel having a touch panel function.

A scanner 207 reads a document, and generates image data. A printer 208 executes printing on a sheet on the basis of an instruction that is input from a user via the operating unit 205 or a command that is input from an external apparatus via a communication unit 209. The communication unit 209 communicates with the image pickup apparatus 101 or the server apparatus 102 via the network 103.

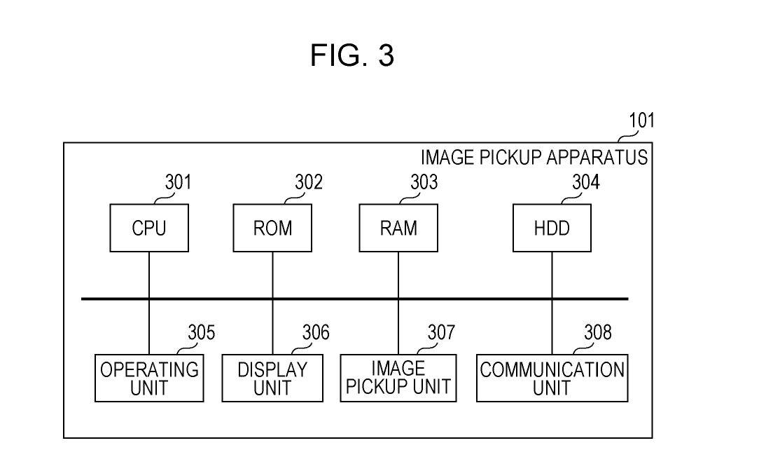

FIG. 3 is a diagram for explaining the configuration of the image pickup apparatus 101.

A CPU 301 reads out control programs stored in a ROM 302 or an HDD 304 to control the entire image pickup apparatus 101. The ROM 302 stores information, such as control programs for executing processes according to, for example, flowcharts described below. A RAM 303 is used as a temporary storage area, such as a main memory or a work area of the CPU 301. Similarly to the ROM 302, the HDD 304 stores information such as control programs for executing processes according to, for example, flowcharts described below.

An operating unit 305, through which a user can input an operation, transmits information that is input from a user to the CPU 301. A display unit 306 displays an operation screen of the image pickup apparatus 101 or a screen for an image that is picked up by an image pickup unit 307. According to the embodiment, the description is made in which the operating unit 305 and the display unit 306 are separately formed. However, they may be integrally formed as in, for example, a liquid crystal panel having a touch panel function.

The image pickup unit 307 is, for example, a CCD camera, and an image picked up by the image pickup unit 307 is displayed on the display unit 306. The image pickup unit 307 reads a code image such as a QR code, and analyzes the code image which has been read, whereby information included in the code image can be obtained. A communication unit 308 communicates with the MFP 100 or the server apparatus 102 via the network 103.

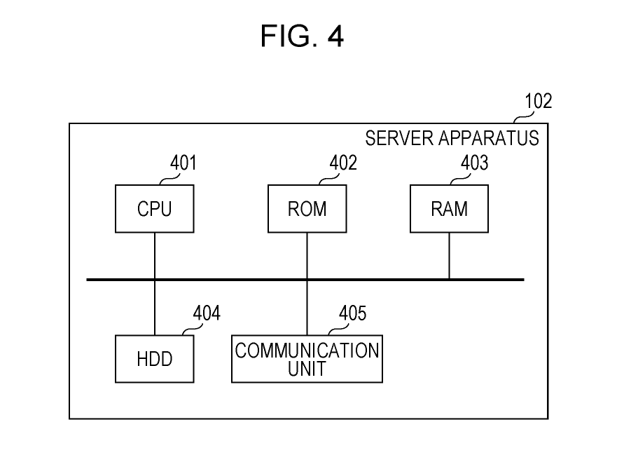

FIG. 4 is a diagram for explaining the configuration of the server apparatus 102.

A CPU 401 reads out control programs stored in a ROM 402 or an HDD 404 to control the entire server apparatus 102. The ROM 402 stores information, such as control programs for executing processes according to, for example, flowcharts described below. A RAM 403 is used as a temporary storage area, such as a main memory or a work area of the CPU 401. Similarly to the ROM 402, the HDD 404 stores information such as control programs for executing processes according to, for example, flowcharts described below. In addition, the HDD 404 stores manuals for various types of MFPs including the MFP 100, as electronic files. A communication unit 405 communicates with the MFP 100 or the image pickup apparatus 101 via the network 103.

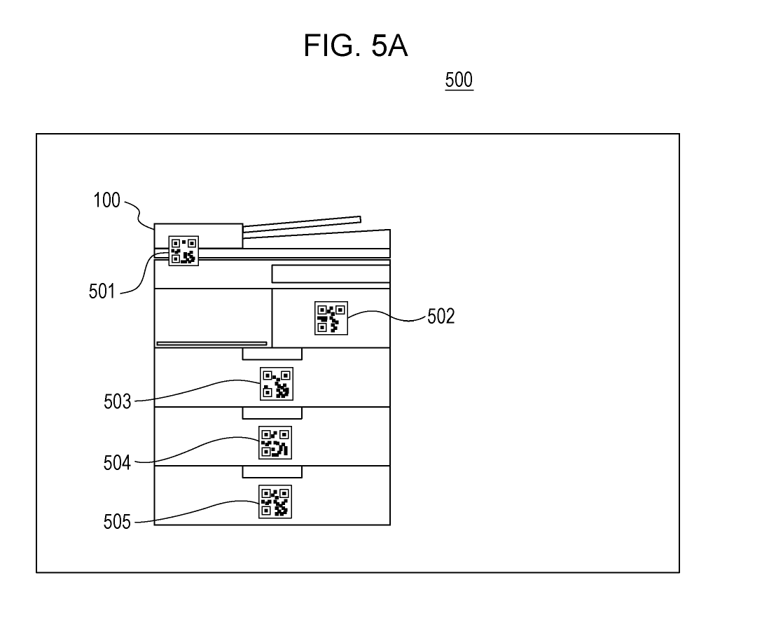

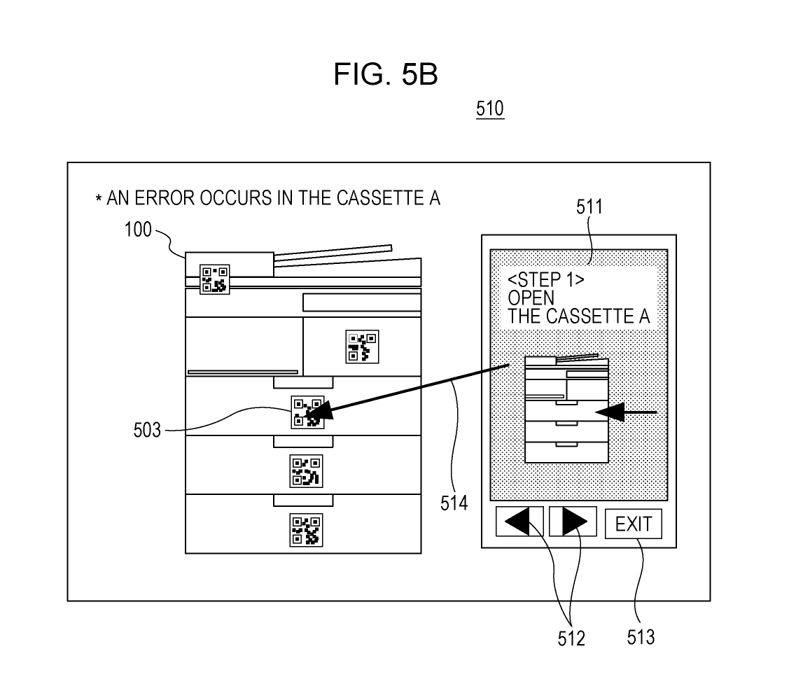

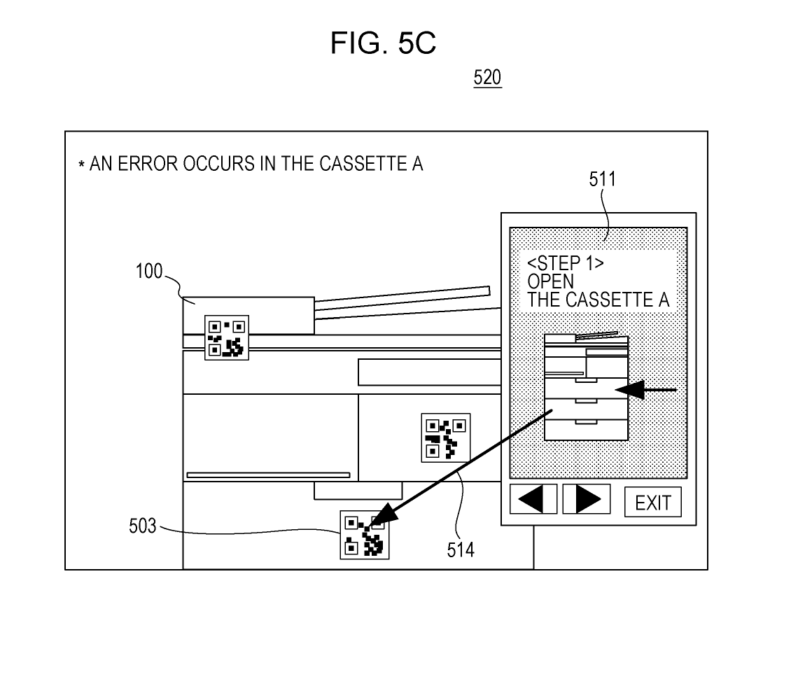

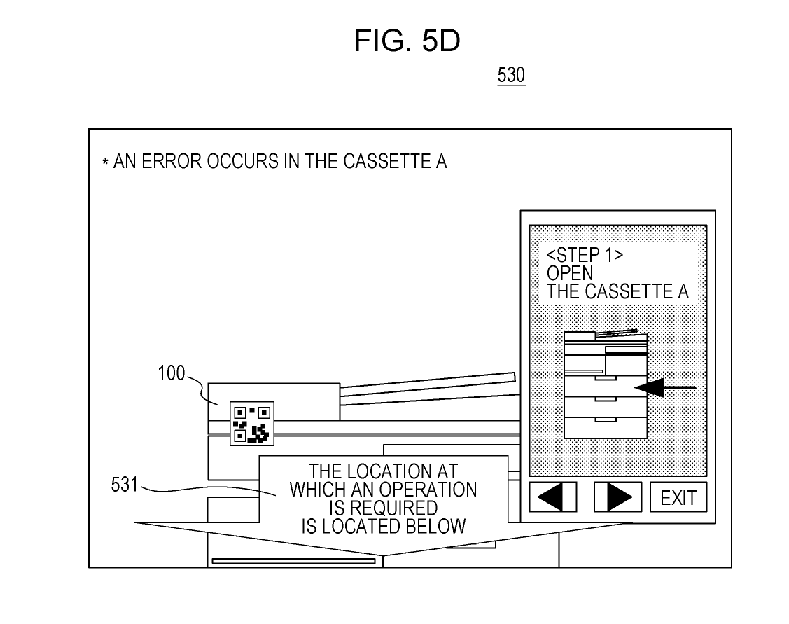

The features of the present invention will be described with reference to FIG. 5. Screens in FIGS. 5A to 5D are screens displayed on the display unit 306 of the image pickup apparatus 101.

A screen 500 is a screen displayed in the case where the MFP 100 which is an object to be photographed is photographed by the image pickup unit 307 and where the photographed image is displayed on the display unit 306. Quick response (QR) codes 501 to 505 are attached to the MFP 100. The QR codes 501 to 505 include information for identifying the type of the MFP 100. Accordingly, the image pickup unit 307 analyzes any one of the QR codes 501 to 505, whereby the image pickup apparatus 101 can identify the type of the MFP 100.

Each of the QR codes 501 to 505 also includes information indicating a particular member of the MFP 100. Specifically, the QR code 501 includes information indicating the operating unit 205 of the MFP 100; the QR code 502, indicating the cover of the MFP 100; the QR code 503, indicating the paper feed cassette A; the QR code 504, indicating the paper feed cassette B; and the QR code 505, indicating the paper feed cassette C.

For example, when the image pickup unit 307 recognizes the QR codes 501, 502, and 503, the image pickup apparatus 101 can detect an image pickup area which includes the operating unit 205, the cover, and the paper feed cassette A. In addition, the image pickup apparatus 101 obtains the configuration of the MFP 100, thereby grasping a state in which the paper feed cassettes B and C are not photographed, and the positional relationship between the members (for example, a relationship in which the paper feed cassettes B and C are located under the paper feed cassette A). The image pickup apparatus 101 obtains the configuration of the MFP 100 from the server apparatus 102 or from the MFP 100 via the network 103. Alternatively, a user inputs the configuration of the MFP 100 into the image pickup apparatus 101 in advance. In the embodiment, a configuration using the QR codes to identify the members of the MFP 100 is described. However, a configuration may be employed in which the image pickup apparatus 101 performs pattern matching on the picked-up image of the MFP 100 to identify the members.

A screen 510 is a screen displayed on the display unit 306 of the image pickup apparatus 101 when an error such as a jam occurs in the paper feed cassette A of the MFP 100. When any error occurs in the MFP 100, status information indicating the error is transmitted from the MFP 100 through the network 103 to the image pickup apparatus 101. According to the embodiment, the status information is transmitted from the MFP 100 to the image pickup apparatus 101 by using a wireless LAN.

The image pickup apparatus 101, which receives the status information indicating an error from the MFP 100, notifies the server apparatus 102 of the status information and information indicating the type of the MFP 100 which is identified from the QR codes. Then, the image pickup apparatus 101 obtains a manual which corresponds to the transmitted status information as well as the type of the MFP 100 (a manual which describes the procedure for solving the error which has occurred in the MFP 100) from the server apparatus 102. In the embodiment, a configuration is described in which the information indicating the type of the MFP 100 is obtained from the QR codes. However, other configurations, such as a configuration in which the information indicating the type of the MFP 100 is received along with the status information, may be employed.

An area 511 in the screen 510 is an area for displaying a manual obtained from the server apparatus 102. Selection of a button 512 allows the displayed page of the manual to be changed to the previous or next page. Selection of a button 513 allows the display of the manual to be ended.

According to the manual in the area 511, it is indicated that the location at which a user is to perform the next operation to solve the error is the paper feed cassette A. According to the embodiment, an arrow 514 is superposed onto the QR code 503 indicating the paper feed cassette A. Accordingly, from the viewpoint of a user, since the arrow 514 is displayed onto the MFP 100 which is actually being photographed, the user can easily identify the location at which the user is to perform the next operation, without an operation of, for example, checking the MFP 100 with the manual.

A screen 520 is a screen displayed on the display unit 306 of the image pickup apparatus 101 when the image pickup area is changed by moving the image pickup apparatus 101 by a user. At that time, since the QR code 503 is displayed, as in the screen 510, the arrow 514 is displayed onto the QR code 503 indicating the paper feed cassette A.

A screen 530 is a screen displayed on the display unit 306 of the image pickup apparatus 101 when a user further moves the image pickup apparatus 101 from the state illustrated in the screen 520. The screen 530 illustrates an example in which a user moves the image pickup apparatus 101 too much, so that the image pickup area does not include the QR code 503. Since the QR code 503, i.e., a display area to which the arrow 514 is to be displayed, is not displayed on the display unit 306, the arrow 514 is not displayed. At that time, a user does not easily recognize the location at which the user is to perform the next operation, compared with the cases of the screens 510 and 520. Accordingly, according to the embodiment, guidance information 531 is displayed which indicates the direction to the location at which the user is to perform an operation. A user moves the image pickup apparatus 101 in the direction indicated by the guidance information 531, so that the QR code 503 and the arrow 514 are displayed again (for example, as in the screens 510 and 520). Thus, a user can identify the location at which the user is to perform an operation. According to the embodiment, since the image pickup apparatus 101 has obtained the configuration of the MFP 100, the image pickup apparatus 101 can display the guidance information indicating an appropriate direction used to display the location at which the user is to perform the next operation, in the image pickup area.

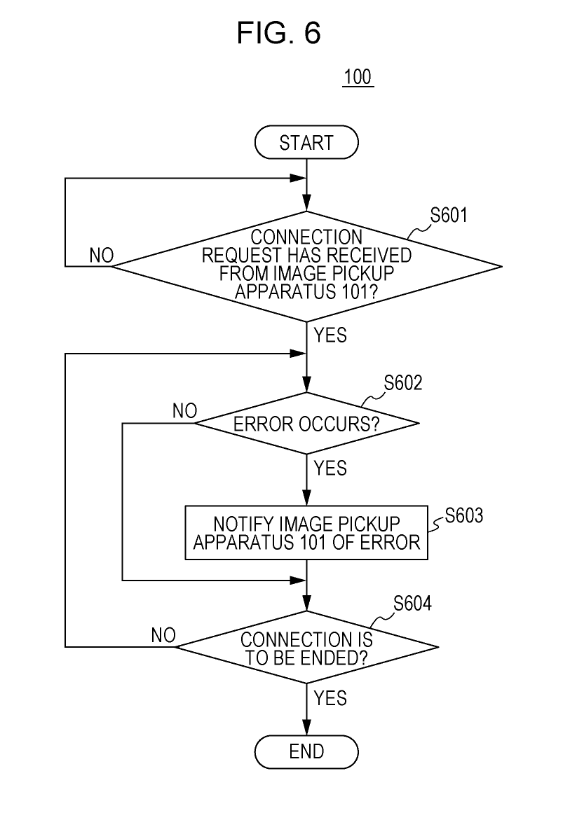

The procedure performed by the MFP 100 will be described using the flowchart in FIG. 6. Steps S601 to S604 each are processed in such a manner that the CPU 201 included in the MFP 100 loads a program stored in a memory such as the ROM 202 into the RAM 203 and executes it.

In step S601, the CPU 201 determines whether or not a connection request has been received from the image pickup apparatus 101. If the CPU 201 determines that a connection request has been received from the image pickup apparatus 101, the CPU 201 starts communication with the image pickup apparatus 101, and the process proceeds to step S602. If the CPU 201 determines that no connection requests have been received from the image pickup apparatus 101, the CPU 201 waits until a connection request is received.

Then, in step S602, the CPU 201 determines whether or not an error, such as a jam or no paper, occurs. If the CPU 201 determines that some error occurs, the process proceeds to step S603. If the CPU 201 determines that no errors occur, the process proceeds to step S604.

In step S603, the communication unit 209 of the MFP 100 notifies the image pickup apparatus 101 of status information indicating the error which has occurred. This status information includes information for identifying the type of the error which has occurred in the MFP 100. In addition, the status information, of which the image pickup apparatus 101 is notified, may include information for identifying the type of the MFP 100.

In step S604, the CPU 201 determines whether or not the connection with the image pickup apparatus 101 is to be ended. If the CPU 201 determines that the connection with the image pickup apparatus 101 is to be ended, the CPU 201 ends the communication with the image pickup apparatus 101, and the process illustrated in the flowchart in FIG. 6 ends. If the CPU 201 determines that the connection with the image pickup apparatus 101 is not to be ended, the process returns back to step S602. The determination whether or not the connection between the MFP 100 and the image pickup apparatus 101 is to be ended may be made depending on whether or not an instruction is input from a user via the operating unit 205 of the MFP 100, or may be made on the basis of a request from the image pickup apparatus 101.

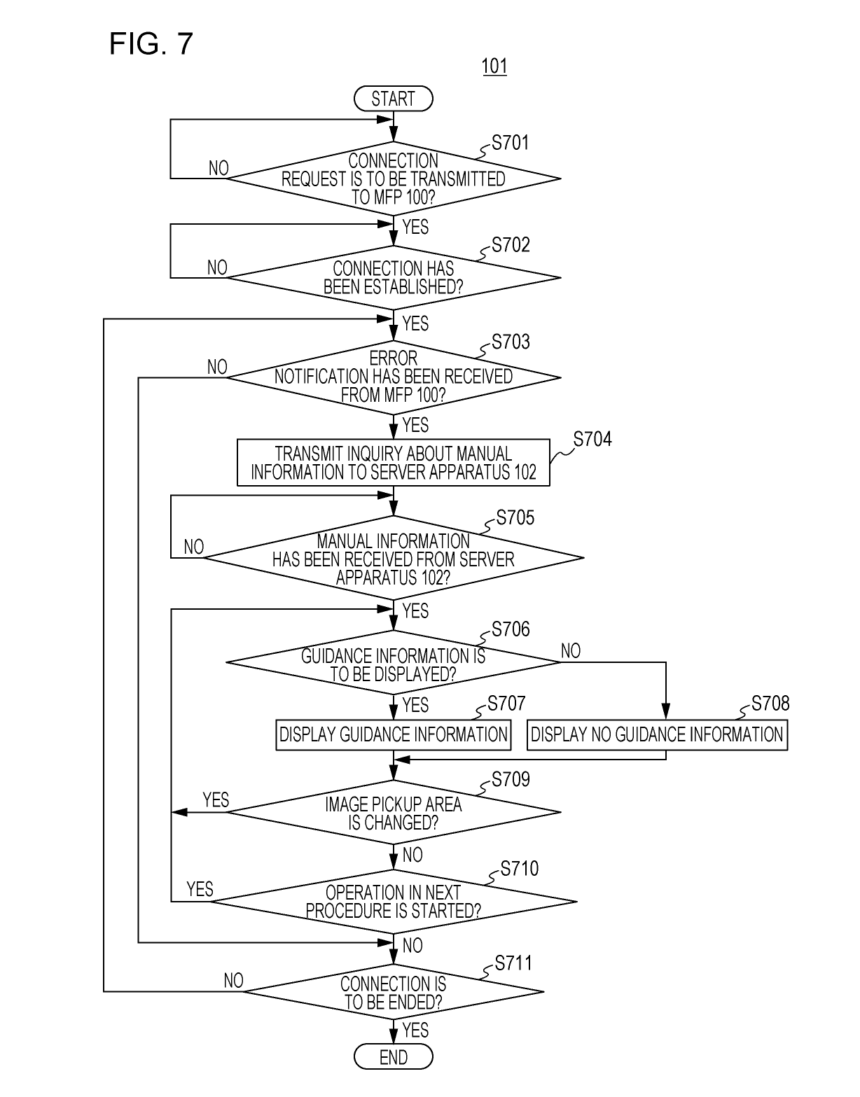

The procedure performed by the image pickup apparatus 101 will be described using the flowchart in FIG. 7. Steps S701 to S711 each are processed in such a manner that the CPU 301 included in the image pickup apparatus 101 loads a program stored in a memory such as the ROM 302 into the RAM 303 and executes it.

When a user photographs the MFP 100 by using the image pickup apparatus 101, the CPU 301 of the image pickup apparatus 101 recognizes QR codes attached to the MFP 100. The QR codes each include information which is necessary to communicate between the image pickup apparatus 101 and the MFP 100, such as an IP address of the MFP 100. The image pickup apparatus 101 transmits a connection request to the MFP 100 on the basis of the IP address obtained from a QR code. The way to obtain information, such as an IP address, which is necessary to communicate between the image pickup apparatus 101 and the MFP 100 is not limited to this. As another example, a user may input an IP address via the operating unit 305 into the image pickup apparatus 101.

In step S701, the CPU 301 determines whether or not a connection request is to be transmitted to the MFP 100. If the CPU 301 determines that a connection request is to be transmitted, the CPU 301 transmits a connection request to the MFP 100, and the process proceeds to step S702. If the CPU 301 determines that a connection request is not to be transmitted, the CPU 301 waits until a connection request is transmitted. The determination whether or not the image pickup apparatus 101 transmits a connection request to the MFP 100 may be made on the basis of whether or not an instruction is input from a user via the operating unit 305 of the image pickup apparatus 101. Alternatively, a connection request may be automatically transmitted when the image pickup apparatus 101 is activated or when an IP address is obtained from a photographed QR code.

In step S702, the CPU 301 determines whether or not a connection with the MFP 100 has been established. If the CPU 301 determines that a connection with the MFP 100 has been established, the CPU 301 starts communication with the MFP 100, and the process proceeds to step S703. If the CPU 301 determines that a connection with the MFP 100 has not been established, the CPU 301 waits until a connection with the MFP 100 is established and communication is to be started.

In step S703, the CPU 301 determines whether or not an error notification (status information), such as a notification of a jam or no paper, has been received from the MFP 100. If the CPU 301 determines that an error notification has been received from the MFP 100, the process proceeds to step S704. If the CPU 301 determines that no error notifications have been received from the MFP 100, the process proceeds to step S711.

In step S704, the CPU 301 transmits an inquiry about manual information corresponding to the error, of which the image pickup apparatus 101 has been notified in step S703, to the server apparatus 102. Specifically, for example, when a notification that a jam occurs in the MFP 100 has been received, the image pickup apparatus 101 transmits an inquiry about a manual about the jam and information indicating a location at which a user is to perform the next operation to solve the jam, to the server apparatus 102.

Note that, in manuals about errors, even for the same error, various manuals are present depending on the types of MFPs. Accordingly, according to the embodiment, when the CPU 301 transmits an inquiry about manual information in step S704, the CPU 301 transmits information for identifying the type of the MFP 100 to the server apparatus 102. The information for identifying the type of the MFP 100 may be obtained from a QR code attached to the MFP 100, or from the error information received in step S703. Alternatively, a user may input information for identifying the type of the MFP 100 to the image pickup apparatus 101. According to the embodiment, information including the following items is referred to as manual information: a manual about an error, and information indicating a location at which a user is to perform the next operation to solve the error.

In step S705, the CPU 301 determines whether or not manual information has been received from the server apparatus 102. If the CPU 301 determines that manual information has been received from the server apparatus 102, the process proceeds to step S706. If the CPU 301 determines that no manual information has been received from the server apparatus 102, the CPU 301 waits until manual information is received from the server apparatus 102.

In step S706, the CPU 301 determines whether or not guidance information is to be displayed. The determination performed in step S706 will be described in detail.

Guidance information is information indicating the direction to a location at which a user is to perform an operation, like the guidance information 531 in FIG. 5D. A user moves the image pickup apparatus 101 (causes the image pickup area to be changed) in the direction indicated by the guidance information, whereby the location at which the user is to perform the next operation can be displayed on the display unit 306 of the image pickup apparatus 101. That is, the determination whether or not guidance information is to be displayed is made on the basis of whether or not the location at which a user is to perform the next operation and which is indicated in the manual information is included in the image pickup area which is being photographed by the image pickup apparatus 101. Specifically, when the location at which a user is to perform the next operation is the paper feed cassette A, the determination is made on the basis of whether or not the QR code 503 corresponding to the paper feed cassette A is displayed in the image pickup area. If the QR code 503 is not displayed in the image pickup area, the CPU 301 determines in step S706 that guidance information is to be displayed, and the process proceeds to step S707. If the QR code 503 is displayed in the image pickup area, the CPU 301 determines in step S706 that no guidance information is to be displayed, and the process proceeds to step S708.

In step S707, the display unit 306 of the image pickup apparatus 101 displays guidance information as well as a manual as in the screen 530 in FIG. 5D. The operation in step S707 will be specifically described. When the location at which a user is to perform the next operation and which is indicated in the manual information is, for example, the paper feed cassette A, the CPU 301 determines the direction to the paper feed cassette A with respect to the current image pickup area. As described above, since the image pickup apparatus 101 has obtained the configuration of the MFP 100 in advance from the server apparatus 102 or the MFP 100, or from an input from a user, the CPU 301 can grasp the positional relationship between the members. Accordingly, the CPU 301 can determine the direction to the paper feed cassette A with respect to the current image pickup area. When the QR codes 501 and 502 are photographed as in the screen 530 in FIG. 5D, the CPU 301 can determine that the QR code 503 corresponding to the paper feed cassette A is located in the downward direction with respect to the current image pickup area. By making the determination in this way, the CPU 301 can display guidance information indicating the direction to a location at which a user is to perform an operation, in step S707, like the guidance information 531 in the screen 530.

In step S708, the display unit 306 of the image pickup apparatus 101 displays the manual without displaying guidance information, as in the screen 510 or the screen 520 in FIGS. 5A and 5B. The reason why guidance information is not displayed is that the CPU 301 has determined that the location at which a user is to perform the next operation is included in the image pickup area, in step S706. In step S708, information indicating the location at which a user is to perform the next operation is displayed along with the manual, as illustrated by the arrow 514.

In step S709, the CPU 301 determines whether or not the image pickup area photographed by the image pickup apparatus 101 is changed. According to the embodiment, the CPU 301 determines that the image pickup area photographed by the image pickup apparatus 101 is changed when information about the QR codes recognized by the image pickup apparatus 101 in the image pickup area is changed. When the image pickup area is changed, the location at which a user is to perform the next operation may be located outside the image pickup area. Accordingly, the process returns back to step S706, and the CPU 301 again determines whether or not guidance information is to be displayed. In step S709, if the CPU 301 determines that the image pickup area is not changed, the process proceeds to step S710.

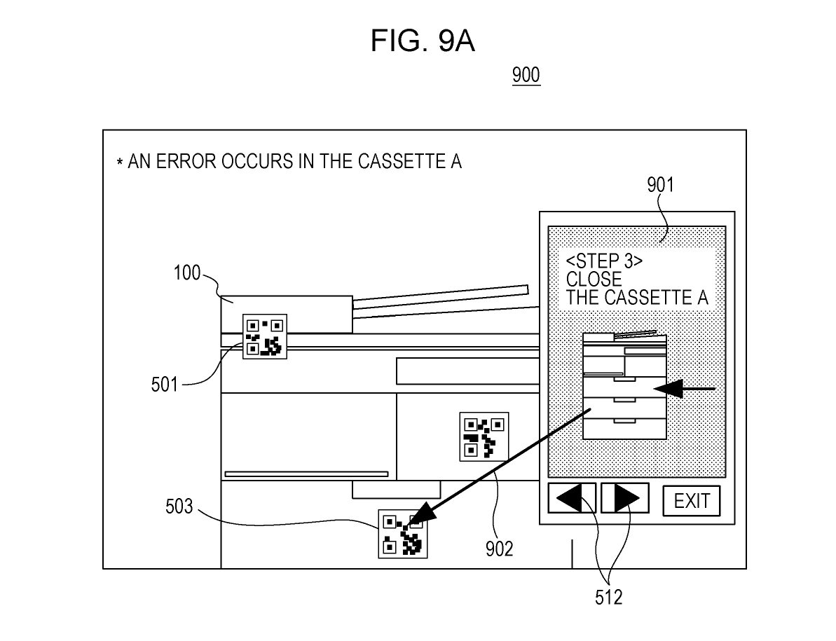

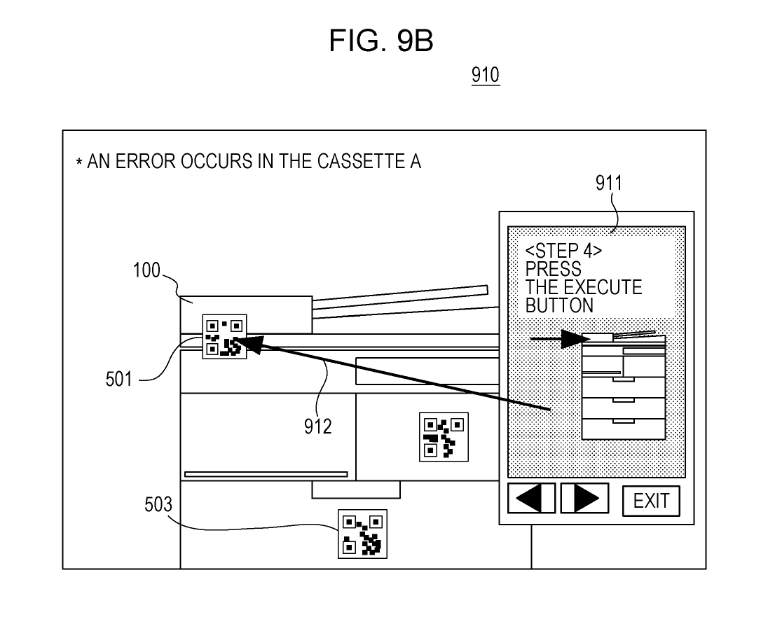

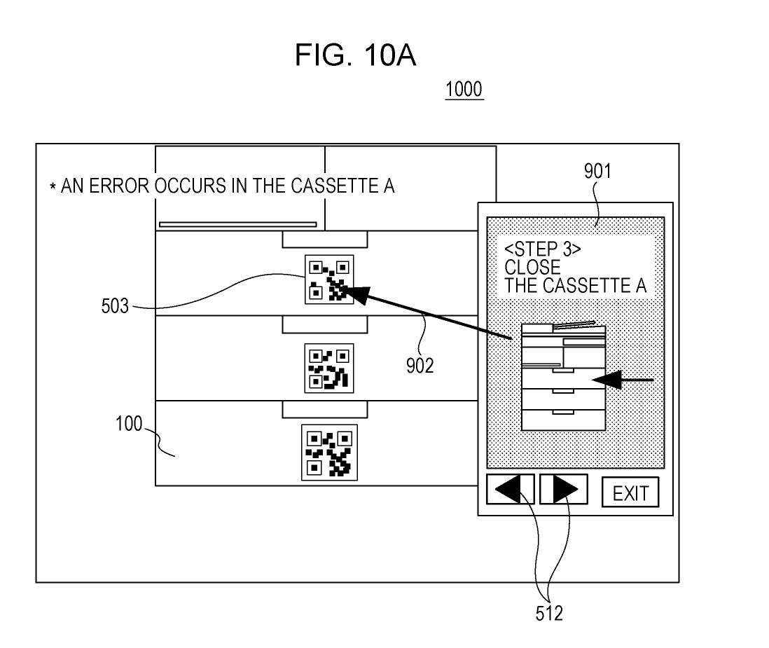

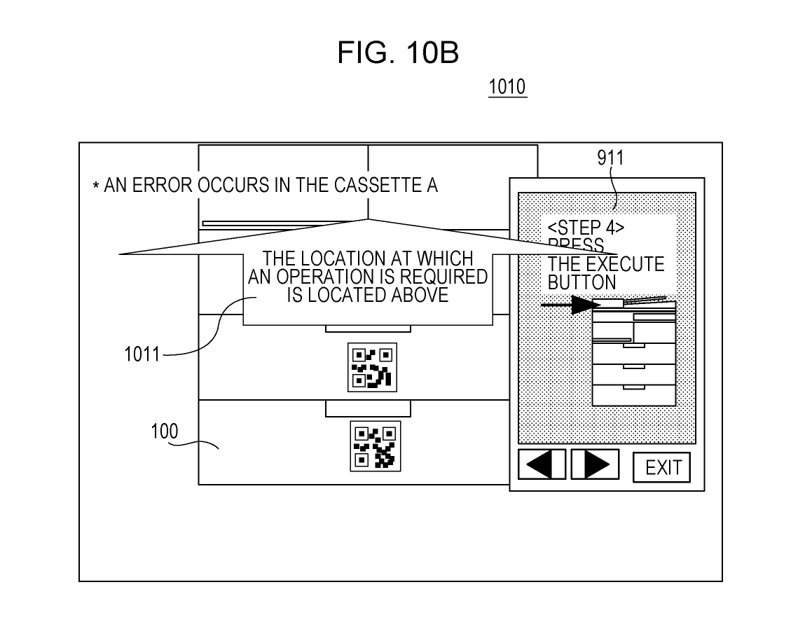

In step S710, the CPU 301 determines whether or not a user has started an operation in the next procedure, such as the next process in the manual. The determination in step S710 will be described in detail with reference to FIGS. 9A to 10B.

FIGS. 9A to 10B each illustrate a screen displayed on the display unit 306 of the image pickup apparatus 101 when a user starts an operation in the next procedure. As in the screens 510 and 520 in FIGS. 5B and 5C, the MFP 100 which is being photographed by the image pickup unit 307, a manual 901, and an arrow 902 are displayed in a screen 900 in FIG. 9A. According to the manual 901, the location at which a user is to perform the next operation is the paper feed cassette A. Accordingly, the arrow 902 is displayed so as to be superposed onto the QR code 503. At that time, when a user uses the button 512 to change the displayed page of the manual to the next page, a screen 910 is displayed. According to a manual 911, the location at which a user is to perform the next operation is the operating unit 205. Accordingly, an arrow 912 is displayed so as to be superposed onto the QR code 501. Thus, since the location at which a user is to perform the next operation is displayed on the MFP 100 which is actually being photographed when the user starts an operation in the next procedure, such as the next process in the manual, the user can easily identify the location at which the user is to perform the next operation in the next procedure.

The description about FIGS. 10A and 10B will be made. A screen 1000 in FIG. 10A is a screen similar to the screen 900 in FIG. 9A, but is different from the screen 900 in that the upper side of the MFP 100 is photographed in the screen 900, whereas the lower side of the MFP 100 is photographed in the screen 1000. According to the manual 901, the location at which a user is to perform the next operation is the paper feed cassette A. Accordingly, the arrow 902 is displayed so as to be superposed onto the QR code 503.

When a user uses the button 512 to change the displayed page of the manual to the next page in the screen 1000, a screen 1010 is displayed. According to the manual 911, the location at which the user is to perform the next operation is the operating unit 205. The operating unit 205 and the QR code 501 corresponding to the operating unit 205, unlike the screen 910, are not displayed. Accordingly, the arrow 912 in the screen 910 is not displayed in the screen 1010. At that time, the user does not easily recognize the location at which the user is to perform the next operation, compared with the case of the screen 1000. Accordingly, according to the embodiment, guidance information 1011 indicating the direction to the location at which the user is to perform the next operation is displayed. The user moves the image pickup apparatus 101 in the direction indicated by the guidance information 1011, so that the QR code 501 and the arrow 912 are displayed. Thus, when a user starts an operation in the next procedure, such as the next process in a manual, the user can easily identify the location at which the user is to perform an operation in the next procedure.

The description will go back to the flowchart. In step S710, the CPU 301 determines whether or not a user has started an operation in the next procedure on the basis of, for example, whether or not a button 512 in FIG. 9A, 9B, 10A, or 10B is selected by the user. If the CPU 301 determines that a button 512 is operated and that the user has started an operation in the next procedure, the process returns back to step S706, and the CPU 301 determines whether or not guidance information indicating the location at which the user is to perform an operation in the next procedure is to be displayed. If the CPU 301 determines that a button 512 is not operated and that the user has not started an operation in the next procedure, the process proceeds to step S711.

According to the embodiment, the description is made in which the CPU 301 determines that a user has started an operation in the next procedure, on the basis of a state in which a button 512 is operated. However, an embodiment to which the present invention can be applied is not limited to this. In another embodiment, for example, a configuration may be employed in which the MFP 100 detects a state in which the cassette A is closed in FIGS. 9A and 10A and in which the MFP 100 transmits a notification that the cassette A has been closed, to the image pickup apparatus 101. The CPU 301 of the image pickup apparatus 101 which receives the notification determines that the user has started an operation in the next procedure in step S710.

The operation in step S711 will be described. In step S711, the CPU 301 determines whether or not the connection with the MFP 100 is to be ended. If the CPU 301 determines that the connection with the MFP 100 is to be ended, the CPU 301 ends the connection with the MFP 100, and the process illustrated in the flowchart in FIG. 7 ends. If the CPU 301 determines that the connection with the MFP 100 is not to be ended, the process returns back to step S703. The determination whether or not the connection between the MFP 100 and the image pickup apparatus 101 is to be ended may be made on the basis of whether or not an instruction is input from a user via the operating unit 305 of the image pickup apparatus 101, or may be made on the basis of a request from the MFP 100.

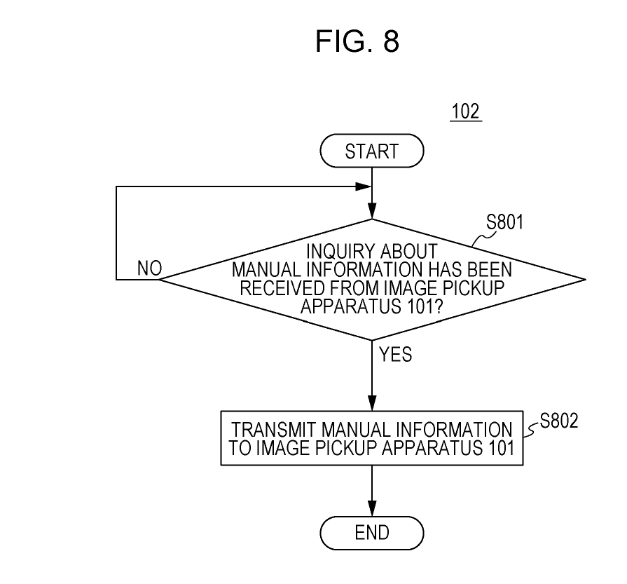

The procedure performed by the server apparatus 102 will be described using the flowchart in FIG. 8. Steps S801 and S802 each are processed in such a manner that the CPU 401 included in the server apparatus 102 loads a program stored in a memory such as the ROM 402 into the RAM 403 and executes it.

In step S801, the CPU 401 determines whether or not an inquiry about manual information which is transmitted from the image pickup apparatus 101 in step S704 in FIG. 7 has been received. If the CPU 401 determines that an inquiry about manual information has been received, the process proceeds to step S802. If the CPU 401 determines that an inquiry about manual information has not been received, the CPU 401 waits until an inquiry about manual information is received.

In step S802, the CPU 401 identifies manual information to be transmitted to the image pickup apparatus 101, on the basis of the error information received in step S801, and transmits the manual information to the image pickup apparatus 101. According to the embodiment, for each of error information types, a manual for solving the error and information indicating the location at which a user is to perform the next operation to solve the error are stored in the ROM 402 or the HDD 404 in the server apparatus 102 in such a manner as to be associated with each other. When the location at which a user is to perform the next operation is, for example, the paper feed cassette A, information indicating the QR code 503 which corresponds to the paper feed cassette A may be transmitted as information indicating the location at which the user is to perform the next operation, or information indicating the paper feed cassette A instead of the QR code 503 may be transmitted. When the information for identifying the type of the MFP 100 is also received in step S801, manual information corresponding to the type of the MFP 100 is transmitted to the image pickup apparatus 101.

As described above, according to the embodiment, not only a manual and information indicating the location at which a user is to perform the next operation but also guidance information indicating the direction to the location at which the user is to perform an operation, such as the guidance information 531, is displayed. Thus, even when the location at which a user is to perform the next operation is not included in the image pickup area, the user can understand how the image pickup apparatus 101 is to be moved. In addition, a user moves the image pickup apparatus, so that the location at which the user is to perform the next operation is displayed with the members of the MFP 100 which is actually being photographed. Accordingly, the user can easily identify the location and the member at which the user is to perform an operation, without an operation of, for example, checking the MFP 100 with the manual.

According to the embodiment, every time a user starts an operation in the next procedure, such as the next process in a manual, the determination is made whether or not guidance information corresponding to the operation in the next procedure is to be displayed. Accordingly, even when the user performs a series of processes (for example, a series of operations for solving an error), the user can easily identify locations at which the user is to perform operations in the next procedure.

### Other Embodiments

According to the first embodiment, the case where multiple errors occur in an MFP is not described. The present invention can be also applied to the case where multiple errors occur. When multiple errors occur, for example, a user may select an error for which the user wants to display a manual. Alternatively, an error for which the user wants to display a manual may be selected on the basis of the predetermined order of priority.

According to the first embodiment, the description is made in which a manual for solving an error is taken as an example. However, the present invention is not limited to this. For example, the present invention may be applied to explanation of a procedure for using a special copy function or a procedure for turning on/off the power of the MFP 100.

According to the first embodiment, the image pickup apparatus 101 transmits an inquiry about status information (for example, information about an error which has occurred in the MFP 100) which is transmitted from the MFP 100, to the server apparatus 102. However, the present invention is not limited to this. For example, the image pickup apparatus 101 may use status information, for example, which is input by a user to the image pickup apparatus 101, to transmit an inquiry to the server apparatus 102, without a notification from the MFP 100 to the image pickup apparatus 101.

According to the first embodiment, the description is made in which the MFP 100, the image pickup apparatus 101, and the server apparatus 102 are individual different apparatuses. However, the present invention is not limited to this. For example, the MFP 100 and the server apparatus 102 may be included in the same apparatus. Alternatively, the image pickup apparatus 101 and the server apparatus 102 may be included in the same apparatus.

The present invention can be also achieved by performing the following process: a process in which software (programs) for achieving the above-described functions according to the embodiments is supplied to a system or an apparatus via networks or various storage media and in which a computer (or, for example, a CPU or a MPU) of the system or the apparatus reads out the programs and executes them.

According to the present invention, guidance information indicating the direction to a location at which a user is to perform an operation is displayed, improving user convenience.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image pickup apparatus comprising:
image pickup means;
display means for displaying an image of an image pickup object picked up by the image pickup means;
determination means for determining whether or not an image of a location at which a user is to perform an operation is picked up by the image pickup means, on the basis of the image pickup object; and
control means for controlling the display means so as to display guidance information indicating a direction to the location at which the user is to perform an operation, in the case where the determination means determines that an image of the location at which the user is to perform an operation is not picked up.

2. The image pickup apparatus according to claim 1,
wherein, when an image pickup area, an image of which is picked up by the image pickup means, is changed, the determination means determines whether or not an image of the location at which the user is to perform an operation is picked up by the image pickup means.

3. The image pickup apparatus according to claim 1,
wherein, when information about an operation which the user is to perform is changed, the determination means determines whether or not an image of a location at which the user is to perform the operation and which corresponds to the changed operation is picked up by the image pickup means.

4. The image pickup apparatus according to claim 1,
wherein in the case where the determination means determines that an image of the location at which the user is to perform an operation is picked up, the control means controls the display means so as not to display the guidance information.

5. The image pickup apparatus according to claim 1,
wherein in the case where the determination means determines that an image of the location at which the user is to perform an operation is picked up, the display means is controlled so as to display information indicating the location at which the user is to perform an operation, in such a manner that the information is superposed on the image pickup object.

6. The image pickup apparatus according to claim 1,
wherein the determination means determines whether or not an image of the location at which the user is to perform an operation is picked up by the image pickup means, on the basis of a code image attached to the image pickup object.

7. The image pickup apparatus according to claim 1,
wherein, by performing pattern matching on an image of the image pickup object, the determination means determines whether or not an image of the location at which the user is to perform an operation is picked up by the image pickup means.

8. A method for controlling an image pickup apparatus, the method comprising:
picking up an image of an image pickup object;
displaying the image of the image pickup object which has been picked up;
determining whether or not an image of a location at which a user is to perform an operation is picked up on the basis of the image pickup object; and
performing control so as to display guidance information indicating a direction to the location at which the user is to perform an operation, in the case where it is determined that an image of the location at which the user is to perform an operation is not picked up.

9. A non-transitory computer-readable storage medium storing a program for causing a computer to execute the method according to claim 8.
